(19) United States
(12) Patent Application Publication
(10) Pub. No.: US 2007/0189887 A1
(43) Pub. Date: Aug. 16, 2007

(54) Removing and installing portable storage containers

(75) Inventor: Ronald Lindblom, New Albany, IN (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/455,597

(22) Filed: Jun. 19, 2006

Related U.S. Application Data
(60) Provisional application No. 60/774,021, filed on Feb. 15, 2006.

(51) Int. Cl. B60P 1/64

(52) U.S. Cl. 414/498

(57) ABSTRACT

Methods, apparatuses, and systems provide, remove, and install a portable storage container (PSC) from and onto a vehicle. A system includes at least two powered jacks communicatively associated with one another. Each powered includes an engagement member formed to lift or lower the PSC, a post movably engaged with the engagement member and mounted to and extended from a support base, and a powered mechanism operatively connected to at least one power source and the engagement member to move the engagement member up or down the post. The system may also include wiring integrated within the PSC that connects the powered mechanism to the power source and communicatively associates the powered jacks with one another. Still further, the system includes a release and mount mechanism external to and integrated with the PSC to secure or release the PSC to or from the vehicle.

### CROSS-REFERENCE TO RELATED APPLICATIONS

This utility patent application claims the benefit under 35 United States Code § 119(e) of U.S. Provisional Patent Application No. 60/774,021 filed on Feb. 15, 2006 which is hereby incorporated by reference in its entirety.

### BACKGROUND

Portable and transferable containers, such as those removably attached to communications service vehicles, can be problematic and cumbersome to remove and install on other vehicles when a communications service vehicle needs servicing or breaks down. As fleet service vehicles age, they break down and are serviced at a higher frequency. When service vehicles fail or require routine maintenance, the equipment stored on the vehicle must either be moved to another vehicle or taken out of service. Thus, the equipment is stored on the vehicle while the vehicle is being serviced. This continued storage can cause loss of the equipment and/or underutilization.

Typically, equipment is manually moved to another vehicle when a communications vehicle needs servicing, such as for preventive maintenance (PM). Conventional container removal systems utilize only manual jacks to lift the container thereby making the removal process lengthy. Another conventional design feature that contributes to the cumbersome and lengthy removal of storage containers is the nut and bolt internal detachment of connection mechanisms. Conventional container systems require a user to detach the container from the vehicle from inside the container. This causes further delay and required access to secured tools or equipment. Thus, when containers have to be removed or service technicians have to use another truck, risky access to the tools and equipment in that truck is inevitable. This also creates issues with service to paying customers and accountability and security for the equipment and tools.

### BRIEF DESCRIPTION OF THE DRAWINGS

FIG. 1 is a perspective view of an equipment container on powered jacks where the powered jacks are operated by a controller according to an illustrative embodiment of the present invention;

FIG. 2 is a perspective view of one powered jack according to an illustrative embodiment of the present invention;

FIG. 3 is a perspective view of an equipment container prior to removal from a service vehicle with powered jacks;

FIGS. 4-5 illustrate top and side views of a rigid tow-bar for use in removing a vehicle from underneath an equipment container; and

FIGS. 6-8 illustrate side and rear views of an equipment container equipped with rollers or casters and a side and top view of a body cart used to remove and/or install the equipment container with rollers or casters.

### DETAILED DESCRIPTION

As briefly described above, embodiments of the present invention provide, remove and/or install portable storage containers (PSCs) from or onto vehicles. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

Referring now to the drawings, in which like numerals refer to like elements through the several figures, aspects of the present invention and an exemplary operating environment will be described. The invention may be practiced in distributed computing environments where tasks are performed by remote processing devices that are linked through a communications network. In a distributed computing environment, program modules may be located in both local and remote memory storage devices.

Embodiments of the invention may be implemented as a computer process, a computing system, or as an article of manufacture such as a computer program product or computer-readable medium. The computer program product may be a computer storage media readable by a computer system and encoding a computer program of instructions for executing a computer process. The computer program product may also be a propagated signal on a carrier readable by a computing system and encoding a computer program of instructions for executing a computer process. These and various other features as well as advantages will be apparent from a reading of the following description and a review of the associated drawings.

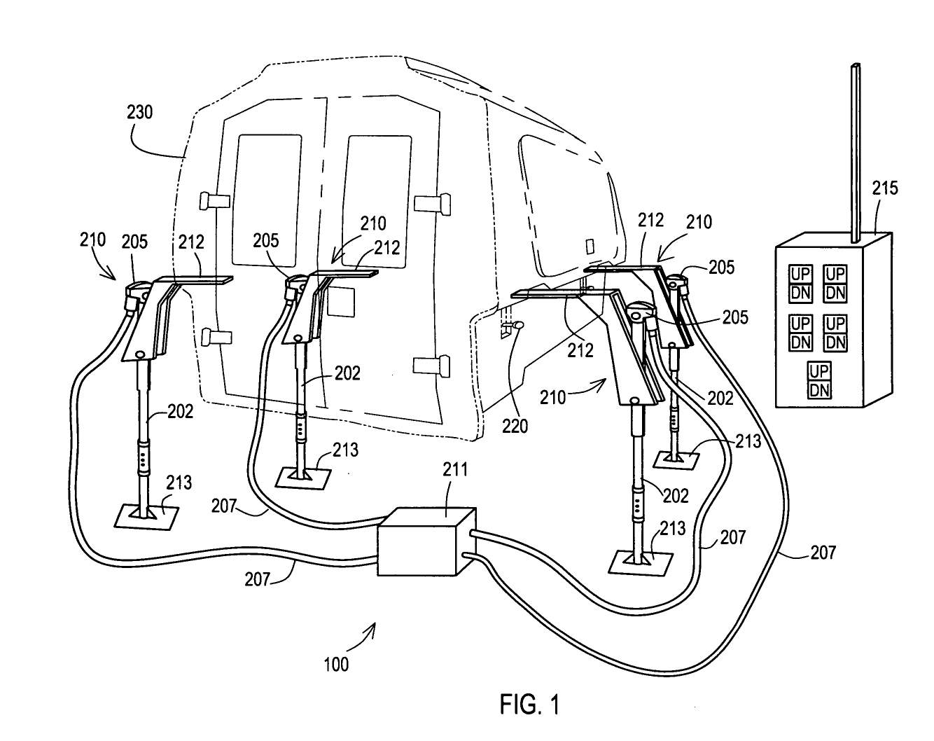

FIG. 1 is a perspective view 100 of a PSC 230 on powered jacks 210 where the powered jacks 210 are operated by a controller 215 according to an illustrative embodiment of the present invention. The PSC 230 that fits on a vehicle is created. This PSC 230 can be removed from the vehicle in a fast and safe manner without the need to open the container. Because some of these PSCs can weigh many hundreds of pounds, the powered jacks 210, such as electric or hydraulic jacks, are connected into the PSC 230. Each powered jack 210 can be wired separately, joined to a power source 211 via wiring 207, and associated with the controller 215. Alternatively, integrating wiring into the PSC 230 to control the multiple electric jacks 210 will eliminate the need for separate wiring between jacks 210.

Still further, embodiments of the present invention synchronize motors 205 of the electric jacks 210 using various methods. For instance, the powered jacks 210 are manipulated via the wired and/or wireless controller 215 and devices in the PSC 230 and/or vehicle. For example, a radio interface can be incorporated between the powered jacks 210 for coordination or synchronization. Each alternative allows the jacks 210 to work in tandem. A computing device, such as the controller 215 for the powered jacks 210, typically includes at least some form of computer-readable media. Computer readable media can be any available media that can be accessed by the controller 215. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, disk drives, a collection of disk drives, flash memory, other memory technology or any other medium that can be used to store the desired information and that can be accessed by the control mechanism 215.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

The controller 215 may include actual switches to operate the powered jacks 210. This controller 215 lifts and lowers the jacks 210. The controller 215 may be equipped with a single switch to move the jacks 210 in concert or it may include a switch for each jack 210 to enable a user to move each jack 210 separately or in concert. For instance, the controller 215 may include four toggle switches. A user can hit all four at the same time to raise them up or, he can move each jack up individually if he wanted to raise one a little higher than the other. It should be appreciated that the controller 215 may be a wireless or wired unit that synchronizes the jacks 210. Still further, in the alternative, each jack 210 may include its own power source such as a battery where each jack 210 is synchronized by the wireless controller 215 via a communications system including the jacks 210, the PSC 230, the vehicle, and/or the wireless controller 215.

Embodiments of the present invention may also include a release and mount mechanism 220 outside of the PSC 230 for ease of access for attachment and detachment of the PSC 230 to and from the vehicle and integrated wiring in the PSC 230 between electric jacks 210 to simplify removal and simplify jack design since no loose wiring 207 would be required between the powered jacks 210. These concepts are applied to not only pick-up trucks, but to bucket trucks and other types of vehicles, including vans and U-bodies (small utility trucks). Once the PSC 230 is lifted up, the vehicle or truck is moved out of the way and then a new truck is put underneath the PSC 230. The PSC 230 is then lowered onto the truck and attached via the release and mount mechanism 220. The release and mount mechanism 220 comes down and pulls against or grabs the edge of the truck. The mechanism 220 includes a bolt that takes approximately 4 turns to detach or attach the PSC 230 to a vehicle. For security purposes the bolt can be equipped with a specialized head requiring the use of a specialized wrench with an extension for removing the PSC 230.

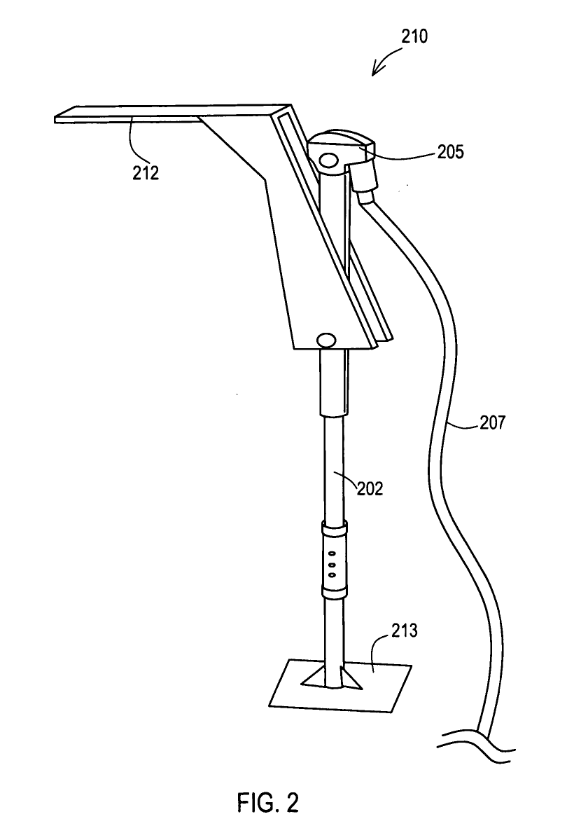

FIG. 2 is a perspective view 200 of one powered jack 210 according to an illustrative embodiment of the present invention. The powered jacks 210 include a flat support plate 213 or a tripod at the bottom of the jacks 210, as also shown in FIG. 1. The one or more powered jacks 210 are communicatively associated with one another. Each of the one or more jacks 210 includes a post 202 including a powered mechanism, such as the electric motor 205 attached. The motor 205 moves a jack engagement member 212 formed to engage the PSC 230 for lifting or lowering the PSC 230 up and down the post 202, such as with a worm gear, planetary gears, or direct drive. The post 202 is movably engaged with the engagement member 212 and mounted to and extended from the support plate 213. The motor 205 is operatively connected to at least one power source and the engagement member 212 therein moving the engagement member 212 up or down the post 202. The jacks 210 may be made of metal such as steel and/or an aluminum composite or alloy, depending on desired strength and/or weight.

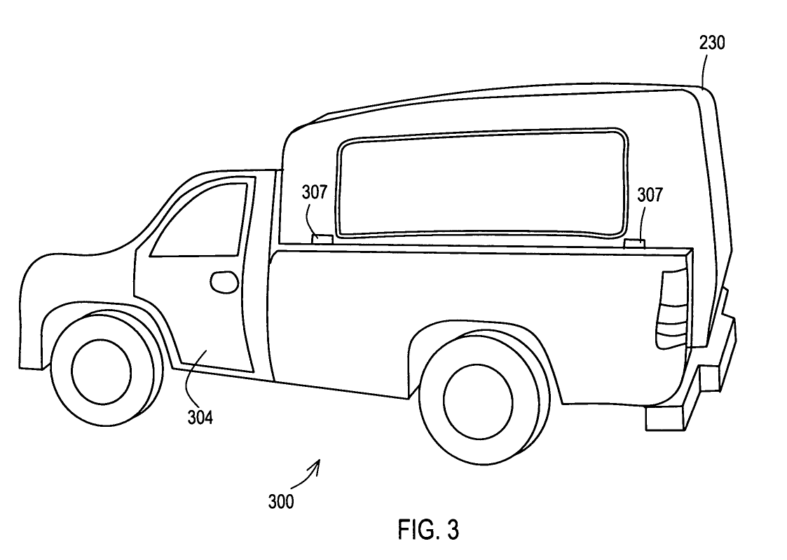

The electric motor 205 may be connected to a power source and the other jacks 210 via the wiring 207. In an alternative embodiment the wiring 207 may plug directly into wiring integrated within the PSC 230 with a connector near the release and mount mechanism 220. The power source 211 may include a separate battery 211 as shown in FIG. 1 or a power source from a vehicle 304 shown in FIG. 3, such as an alternator, battery, or via a pig tail, the trailer socket on the vehicle 304. FIG. 3 is a perspective view of the PSC 230 prior to removal from the service vehicle 304 with the powered jacks 210. Power sources with a twelve (12) volt rating may be sufficient to lift the container 230 with the jacks 210. AC or DC current may be used. The PSC 230 includes indented sections or jack lift points 307 to receive the jack engagement member 212. The wiring 207 goes from one jack 210 to another and connects the jacks 210 together.

The sequential steps for using the apparatus, the jacks 210, the release and mount mechanism 220 and the PSC 230 include a variety of methodologies. For instance, when there are several vehicles, for example 40, at a work center location, a set of powered jacks 210 are left at the work center. A staging location is made available where the trucks or vehicles are pulled into so the jacks would not have to be moved around the yard.

In another embodiment, a work center where there are four or five trucks may have jacks 210 that are kept in a base or shuttle vehicle from a central garage. The driver would drive the shuttle vehicle with the jacks 210 with him. He jacks up the PSC 230, pulls the truck out that needs to be maintained, puts the shuttle truck he drove down underneath the PSC 230 as the vehicle that will now be married to the PSC 230, and then drives the other vehicle back for maintenance and/or service. Thus, instead of making four trips to swap entire vehicle and PSC 230 assemblies per maintenance or repair cycle, he only makes two trips per maintenance or repair cycle. Other benefits include time savings, less mileage and fuel use, less operator and labor expense, and less vehicle wear and tear. Once the PSC 230 is installed on the shuttle truck, the driver puts the jacks 210 in the truck that needs maintenance and drives it back to the central garage. That truck he drives back may not be redeployed again until he has to go out and get another truck that needs to be maintained. The trucks will change but the PSC 230 will stay at the same location.

This aspect also helps in the area of accountability because only the technician assigned to a PSC 230 will use the PSC 230. Also, when a new service truck is brought to a driver, all current damages on the truck are listed on a note left with the truck. The note will also list if there is no current damage to the truck. When the truck is picked up again, it is expected to be the same way. If not, it is reported and the driver is accountable for the damage.

According to an illustrative embodiment, when the driver from the central garage approaches a vehicle, the first thing that he would do is make sure he has a level area. Then he puts the jacks 210 in place and powers them up. Next, the PSC 230 is disconnected from the vehicle using the release and mount mechanism from the outside of the PSC 230. Each bolt is turned approximately four and a half turns to unlock the PSC 230 from the truck. He then installs the one or more jacks 210. The jack 210 slips into the cavities created by the jack lift points 307 on the side of the PSC 230. In one example, the engagement member 212 on the top of the jack 210 is four to five inches wide by about eight inches deep. The engagement member 212 plate slides into the cavity of the PSC 230 at all jack lift points 307.

Next the wiring 207 are connected to energize the jacks 210, for instance by plugging them into the socket at the back end of the truck, the connector. Next the controller 215 is used to raise the PSC 230 up, approximately three (3) inches. Next, the technician pulls the truck out, parks it, pulls the other truck back in, and then reverses the steps to lower the PSC 230. Next, the unit is lowered down, the jacks 210 are removed, and the PSC 230 is secured to the end of the truck. An indicator may be present to assure a user that the PSC 230 is locked down. A user can just look at the indicator and know that the PSC 230 is locked down. For instance, a white color on the indicator could mean the PSC 230 is locked down or a red color could indicate that the PSC 230 is not locked down.

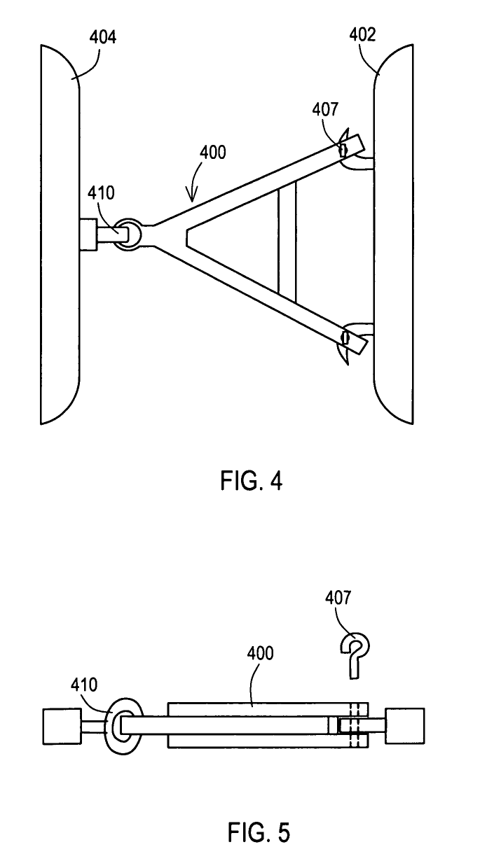

FIGS. 4-5 illustrate top and side views of a rigid tow-bar 400 for use in removing a vehicle from underneath a PSC 230. If the truck is being changed out because it will not start and a tow truck is not available, a tow-bar may be necessary to remove the disabled truck that will not start. The tow-bar 400 connects to the front of the disabled vehicle 402, via one or more pins 407, and the rear of the replacement truck 404. The tow-bar 400 may connect to a pintel hook 410 of the replacement truck 404.

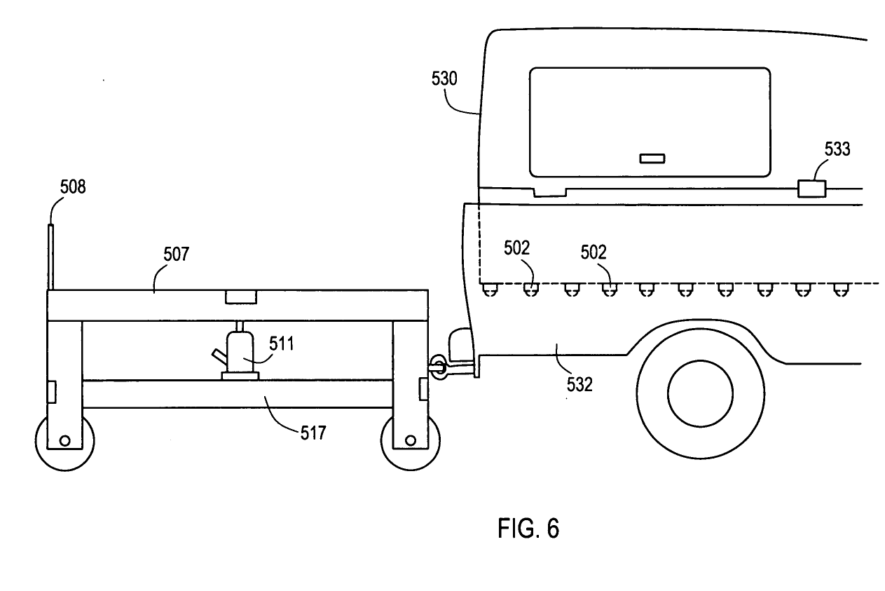

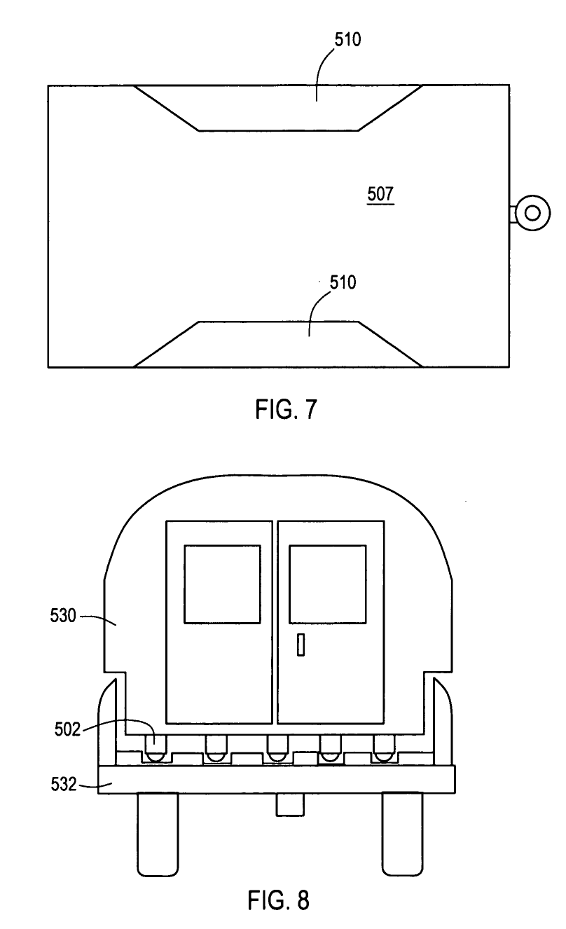

FIGS. 6-8 illustrate side and rear views of a PSC 530 equipped with wheels, rollers including, but not limited to, ball bearings, or casters 502 and a side and top view of a body cart 507 used to remove and/or install the PSC 530 with roller wheels or casters 502 rotatably engaged with a bottom surface of a body cavity of the PSC 530 in order to roll the PSC 530 onto or away from a surface of a vehicle 532. The PSC 530 may be equipped with jack lift points 533. However, the PSC 530 can be detached from a vehicle 532 using a release and mount mechanism accessible from outside the PSC 530, and rolled back onto the body cart 507 on the casters 502. In the alternative, it should be appreciated that the rollers or casters may be embodied in the surface of the vehicle 532 and in a top surface of the body cart 507 to roll a PSC not equipped with rollers off and onto the vehicle 532.

The body cart 507 includes a backstop 508, a height adjustment jack 511 and cross supports 517. The body cart 507 also includes guides 510 to guide the PSC 530 onto the body cart 507. It should be appreciated that the number of casters 502 or jacks 511 may vary according to a design of the lift or removal/installation system. The PSC 530 may come equipped with wiring instead of the wires being transported with the jacks 511.

Embodiments of the present invention can be used with any vehicle and a variety of PSC designs including bucket trucks. For instance, a base of bucket trucks with the cabinets or the storage bins detachable from the truck can use the same concept. The storage bins are removed from the truck and placed with another base vehicle.

Still further, communications systems, such as GPS tracking, can be installed in a PSC instead of the vehicle, thus, avoiding the need for system updates when a technician changes vehicles. This way a database or communications system, such as the GPS tracking system, does not have to be updated because the PSC or the toolbox would always be with the driver. For instance, an ICU Unit that is usually located in the back of a truck behind the seat can be moved to the PSC.

As briefly described above, a variety of containers and vehicles can utilize embodiments of the present invention, for example, trailers that are used for fiber splicing. It should be appreciated that hydraulics and/or air may be used as an alternate power source for the jacks.

Thus, the present invention is presently embodied as methods, systems, apparatuses, computer program products or computer readable mediums encoding computer programs for providing, removing, and installing a PSC from and onto a vehicle.

It will be apparent to those skilled in the art that various modifications or variations may be made in the present invention without departing from the scope or spirit of the invention. Other embodiments of the present invention will be apparent to those skilled in the art from consideration of the specification and practice of the invention disclosed herein.

We claim:

1. A system for removing and installing a portable storage container (PSC) from and onto a vehicle, the apparatus comprising:
at least two powered jacks communicatively associated with one another, each powered jack comprising:
an engagement member formed to engage the PSC for vertically moving the PSC;
a post movably engaged with the engagement member and mounted to and extended from a support base; and
a motor operatively connected to at least one power source and the engagement member and for vertically moving the engagement member relative to the post, thereby vertically moving the PSC.

2. The system of claim 1, further comprising wiring integrated within the PSC wherein the motor is connected the power source and the powered jacks are communicatively associated with one another via the wiring.

3. The system of claim 1, further comprising a release and mount mechanism external to and integrated with the PSC wherein the PSC is attached to or detached from the vehicle via the release and mount mechanism without having to open an internal area of the PSC.

4. The system of claim 3, wherein the release and mount mechanism includes a bolt for use in releasably securing the PSC to the vehicle and wherein the bolt is equipped with a specialized head requiring use of a specialized wrench to remove the bolt from the PSC.

5. The system of claim 1, further comprising a controller communicatively associated with the powered jacks wherein the controller comprises one or more control switches that operate the powered jacks.

6. The system of claim 5, wherein the controller is equipped with a single switch that initiates lifting and lowering of all the powered jacks in concert.

7. The system of claim 5, wherein the controller is equipped with a plurality of switches that comprise four toggle switches, each toggle switch operatively associated with a powered jack.

8. The system of claim 5, wherein the controller comprises a wireless unit that synchronizes the powered jacks.

9. The system of claim 5, wherein the controller comprises a wireless control mechanism and the at least one power source comprises a plurality of power sources, each power source operatively associated with one of the powered jacks; and
wherein the powered jacks are synchronized via the wireless controller.

10. The system of claim 1, wherein the power source comprises one of the following:
a battery separate from the PSC and the vehicle;
an alternator integrated with the vehicle or the PSC;
a battery integrated with the vehicle or the PSC; and
a power source accessed via a trailer socket on the vehicle.

11. The system of claim 1, wherein the support base comprises a flat plate.

12. The system of claim 1 wherein the powered mechanism comprises an electric motor.

13. A method for removing or installing a portable storage container (PSC) from or onto a vehicle, the method comprising:
engaging at least two powered jacks with the PSC, wherein the powered jacks are communicatively associated with each other;
vertically moving the PSC relative to the vehicle;
synchronizing the powered jacks to move the PSC in a vertical direction relative to the vehicle; and
releasably securing the PSC to the vehicle.

14. The method of claim 13, wherein engaging the at least two powered jacks comprises:
positioning an engagement member of each jack into a lift location cavity on a side of the PSC; and
energizing the at least two jacks by associating the jacks with a power source.

15. The method of claim 13, wherein vertically moving comprises detaching the PSC by loosening a release and mount mechanism integrated with the PSC from the vehicle and the method further comprising:
attaching the PSC by tightening the release and mount mechanism to the vehicle; and
indicating whether the release and mount mechanism is locked.

16. The method of claim 13, wherein synchronizing the powered jacks to move the PSC comprises:
adjusting each of the powered jacks according to communication received from a control box wherein the control box comprises at least one of a switch associated with each powered jacks.

17. A portable storage container (PSC) for facilitating efficient removal or installation of the PSC from or onto a vehicle, the PSC comprising:
a body cavity;
a plurality of casters rotatably engaged with a bottom surface of the body cavity in order to roll the PSC along a surface of the vehicle; and
a release and mount mechanism integrated with the PSC for releasably securing the PSC to the vehicle.

18. The PSC of claim 17, wherein the release and mount mechanism is accessed external to the PSC.

19. The PSC of claim 17, further comprising a body cart for receiving the PSC upon removing the PSC from the vehicle, wherein the body cart comprises:
a backstop to prevent the PSC from rolling off the body cart;
a height adjustment jack to vertically move the body cart relative to the vehicle; and
guides to guide the PSC onto the body cart.

20. The PSC of claim 17, wherein the PSC further comprises a GPS tracking system.
